(19) United States
(12) Patent Application Publication
(10) Pub. No.: US 2025/0141293 A1
(43) Pub. Date: May 1, 2025

(54) Winding for an Electric Machine, Electric Machine and Manufacturing Method

(71) Applicant: Elaphe Propulsion Technologies, Ltd., Ljubljana (SI)

(72) Inventors: Luka VODEB, Sromlje (SI); Gasper SUSTERSIC, Ljubljana-Sentvid (SI); Gorazd GOTOVAC, Ljubljana (SI)

(21) Appl. No.: 18/847,212

(22) PCT Filed: Mar. 13, 2023
(86) PCT No.: PCT/EP2023/056324

§ 371 Date: Sep. 13, 2024

(30) Foreign Application Priority Data
Mar. 15, 2022 (DE) 10 2022 106 018.7

(51) Int. Cl. H02K 3/28; H02K 1/16; H02K 1/26; H02K 3/12; H02K 15/062

(52) U.S. Cl. CPC H02K 3/28; H02K 1/16; H02K 1/26; H02K 3/12; H02K 15/062

(57) ABSTRACT

The present invention provides a compact winding for multi-phase electric machines. For each phase, a conductor with a specifically shaped overhang portion is provided. All but one of the various overhang portions are provided with a U-bent portion to accommodate a traversing portion of at least one of the other conductors. The width of the U-bent portions differs from phase to phase so that conductors can be inserted into the stator slots in a staggered fashion. A step deformation which has the same shape for all phases, is used for connecting different layers of the winding. Electric contacts to the windings are provided at the overhang portions without deviating from the staggered arrangement of traversing conductor portions.

### TECHNICAL FIELD

The present invention relates to electric machines, and in particular to a compact geometry for windings for electric machines, electric machines with such a winding, and a method for manufacturing such windings.

### BACKGROUND OF THE INVENTION

In conventional electric machines, the windings act as an active motor component. A current through the winding conductors, which are arranged in a magnetic field, generates a torque that rotates the machine. The electric machine thus converts electric energy (current) into mechanical energy (motion). For the propulsion of electric cars and other vehicles, electric machines with high power and high torque are required that are characterized by low mass, low volume, and high energy efficiency. In order to achieve these design goals, compact windings for electric machines are sought.

Various different winding geometries for electric machines are known in the art. Patent documents WO 03/094328 A1 and WO 05/117243 A1, for instance, disclose windings with a large number of discrete coils. The production and assembly of a large number of coils, however, is costly and time-consuming. Moreover, windings with discrete coils suffer from inferior mechanical properties and require a large number of electrical contacts.

As an alternative, block-coils are known in the art, wherein all coils of the same phase are made as one single continuous piece, which is inserted into the slots of a ferromagnetic core. Patent document WO 2005/050816 A2, for instance, discloses a block winding formed as a lap winding, in which each conductor circles a single magnetic pole multiple times before moving to the next pole. The problem of the lap winding is also a lack of space for the crossings of the winding overhangs of adjacent coils for the larger number of turns around every single stator tooth or the group of teeth. An additional problem is to non-destructively insert the conductors into the slots.

These problems are partly avoided by a block winding configuration known as wave winding. In a wave winding geometry, the conductor is shaped into meanders, which wind between the magnetic poles, so that the same conductor returns to the same slot only in the next stage of the winding.

Patent document WO 2006/110498 A1 discloses a wave winding geometry with a small number of electric conductors per slot, wherein conductors may be cut from cooper sheets and may thus be provided with any profile shape. Patent document U.S. Pat. No. 8,082,653 B2 also discloses a method for producing a rectangular winding by twisting the overhangs into a wire bundle and folding the bundle into coils to produce a coil without any undesirable deformations of the phase windings.

However, even a wave winding with a low number of conductors suffers from the problem of the neighbouring winding overhangs crossing at both axial sides of the stator, outside of the ferromagnetic core. In this region, electrical conductors are not straight and parallel, but curved. This problem is particularly pronounced in multiphase machines with a plurality of conductors of several phases crossing each other in a limited space for all the winding overhangs, especially in cases where the number of the layers of the winding is two or more. Also, the problem of the conductors' insertion order of the individual phases into the ferromagnetic core, so that the winding in which the overhang cross ends up efficiently from the topological point of view is not solved yet.

In a wave winding with a small number of electrical conductors per slot, the conductors are relatively thick and sturdy. Therefore, the winding overhangs cannot be bent easily into the correct shape that is required for a tight fit of all winding overhangs. During insertion of the coil into the ferromagnetic core, the winding overhangs can only be forced into the correct shape with significant pressure, which causes the risk of damages to the winding.

Patent document JP 2004/282 996 A discloses a stator winding with a cascaded end loop. By using a rectangular conductor, a high slot-fill-ratio stator can be achieved. The conductors are aligned in a radial row within each slot and are precisely fitted to the width of the rectangular core slot. High slot filled stators are advantageous because they are efficient and generate more power per winding than other prior art stators. However, typically these stators are deficient in that the windings are interlaced (i.e., the wires need to be crossed at the radially outer and inner portions of each slot). These interlaced windings require an interlacing process that bundles phase conductors together before inserting the windings into the stator core. This increases complexity.

Hairpin conductors are used in other prior art stators. In the stator disclosed in U.S. Pat. No. 10,965,178 B2, for instance, a hairpin shaped conductor is disposed in the core slot from the upper or lower axial end of the stator core. Although hairpin conductors are not interlaced, the difficulty of manufacturing the stator is still increased because both ends of the hairpin shaped conductor must be welded to form the stator windings.

Hence, there is a need for a stator that satisfies the requirements of high slot fill ratio and yet does not require a complex interlacing winding processes or a large number of welding contacts of hairpin conductors.

### SUMMARY OF THE INVENTION

All known solutions have problems with regard to cost, weight, maximum torque, energy efficiency, and manufacturing complexity.

Therefore, it is an object of the present invention to overcome these problems and to provide a winding for an electric machine with a compact geometry that enables high power and high torque electric machines with low mass, low volume and high energy efficiency. It is a further aim of the present invention to provide a method for manufacturing such windings in a cost-efficient manner, in particular by inserting individual conductors one-by-one in several layers while requiring as few welding contacts as possible.

This is achieved by the features of the independent claims. Preferred embodiments are the subject matter of the dependent claims.

The winding geometry disclosed herein provides an optimum fit of neighbouring winding overhangs, so that the winding has a large density, is compact and easy to manufacture at the same time. Electric machines with such a winding can achieve a high specific torque and power, have excellent energy efficiency, are characterized by a high heat transfer coefficient and a high heat conductivity from the winding to the stator core, and excel with improved cooling of the machine and easy assembly process of the motor.

The invention is useful for the propulsion of electric cars and other vehicles, in particular for vehicles with direct drive in-wheel, for the propulsion of rotating machines general and in a variety of other fields where electric motors/generators are used.

It is the particular approach of the present invention to provide a specific geometry for the overhang of each phase, namely an overhang with a U-bent portion having a width that differs from phase to phase and that is adapted to accommodate a traversing portion for at least some of the other phases.

According to a first aspect of the present invention, a winding for an electric machine is provided. The winding comprises a first conductor (100), a second conductor (200), and a third conductor (300). Each of the first conductor (100), the second conductor (200) and the third conductor (300) comprises two parallel conductor portions (110, 120, 210, 220, 310, 320) connected by an overhang portion (130, 230, 330). A first parallel conductor portion (110) of the first conductor (100) is configured to be inserted into a first slot of a plurality of slots of a rotor or a stator of the electric machine. A first parallel conductor portion (210) of the second conductor (200) is configured to be inserted into a second slot of the plurality of slots adjacent to the first slot. A first parallel conductor portion (310) of the third conductor (300) is configured to be inserted into a third slot of the plurality of slots adjacent to the second slot and different from the first slot. A second parallel conductor portion (120) of the first conductor (100) is configured to be inserted into a fourth slot of the plurality of slots different from the first slot, the second slot, and the third slot. A second parallel conductor portion (220) of the second conductor (200) is configured to be inserted into a fifth slot of the plurality of slots adjacent to the fourth slot and different from the third slot. A second parallel conductor portion (320) of the third conductor (300) is configured to be inserted into a sixth slot of the plurality of slots adjacent to the fifth slot and different from the fourth slot. The winding is characterized in that the overhang portion (130) of the first conductor (100) comprises a first U-bend portion (190) in a direction perpendicular to a plane defined by the two parallel conductor portions (110, 120), the first U-bend portion (190) being formed so as to accommodate a traversing part of the overhang portion (230) of the second conductor (200) and a traversing part of the overhang portion (330) of the third conductor (300). The overhang portion (230) of the second conductor (200) comprises a second U-bend portion (290) in a direction perpendicular to a plane defined by the two parallel conductor portions (210, 220), the second U-bend portion (290) being formed so as to accommodate a traversing part of the overhang portion (330) of the third conductor (300). The overhang portion (330) of the third conductor (300) is contained within a plane defined by the two parallel conductor portions (310, 320).

The first conductor (100), the second conductor (200) and the third conductor (300) may correspond to a first phase of the winding, a second phase of the winding, and a third phase of the winding, respectively.

In a preferred embodiment, the winding has a total of three phases. In this case, the fourth slot is adjacent to the third slot. In an alternative embodiment, the winding has a total of N phases, N being an integer greater than 3, and the fourth slot is arranged N−3 slots apart from to the third slot.

Further, a width of the first U-bend portion (190) may correspond to a pitch of the plurality of slots plus a width of one of the plurality of slots, and a width of the second U-bend portion (290) may correspond to the width of one of the plurality of slots.

Further, each of a depth of the first U-bend portion (190) and a depth of the second U-bend portion (290) may correspond to a width of the third conductor (300) in a direction perpendicular to the plane defined by the two parallel conductor portions.

According to another preferred embodiment, each of the overhang portions (130, 230, 330) of the first, the second, and the third conductor (100, 200, 300) comprises an extension portion (140, 240, 340) connected to, and possibly collinear with, the first parallel conductor portion (110, 210, 310), a first curved portion (150, 250, 350) connected to the extension portion (140, 240, 340), a diagonal portion (160, 260, 360) connected to the first curved portion (150, 250, 350), and a second curved portion (170, 270, 370) connecting the diagonal portion (160, 260, 360) and the second parallel conductor portion (120, 220, 320). Moreover, the first U-bend portion (190) is arranged in the diagonal portion (160) of the overhang portion (130) of the first conductor (100) and the second U-bend portion (290) is arranged in the diagonal portion (260) of the overhang portion (230) of the second conductor (200).

The overhang thus forms a right triangle with the hypotenuse being formed by the diagonal portions (160, 260, 360). The first curved portion may thus form (150, 250, 350) an acute angle and the second curved portion (170, 270, 370) may form an obtuse angle.

With such a configuration, the extension portion (140, 240, 340) of each of the overhang portions of the first, the second, and the third conductor (100, 200, 300) may have a length that allows the overhang portion (330) of the third conductor (300) to traverse the first U-bend portion (190) in the overhang portion (130) of the first conductor (100) and the second U-bend portion (290) in the overhang portion (230) of the second conductor (200).

Moreover, the first U-bend portion (190) may be formed such that its trough accommodates the extension portion (240) of the second conductor (200) and the extension portion (340) of the third conductor (300), the second U-bend portion (290) may be formed such that its trough accommodates the extension portion (340) of the third conductor (300), and a trough in the first U-bend portion (190) may be wider than a trough in the second U-bend portion (290).

Preferably, each of the first, the second, and the third conductor (100, 200, 300) further comprises a plurality of parallel conductor portions (110, 120, 210, 220, 310, 320) serially connected by a plurality of overhang portions (130, 230, 330).

According to another preferred embodiment, the winding further comprises a fourth conductor (400), a fifth conductor (500), and a sixth conductor (600), each of the fourth conductor (400), the fifth conductor (500) and the sixth conductor (600) comprising two parallel conductor portions connected by an overhang portion. A first parallel conductor portion of the fourth conductor (400) is configured to be inserted into the fourth slot on top of the second parallel conductor portion of the first conductor (100). A first parallel conductor portion of the fifth conductor (500) is configured to be inserted into the fifth slot on top of the second parallel conductor portion of the second conductor (200). A first parallel conductor portion of the third conductor (600) is configured to be inserted into the sixth slot on top of the second parallel conductor portion of the third conductor (300). A second parallel conductor portion of the fourth conductor (400) is configured to be inserted into a seventh slot of the plurality of slots adjacent to the sixth slot and different from the fifth slot. A second parallel conductor portion of the fifth conductor (500) is configured to be inserted into an eighth slot of the plurality of slots adjacent to the seventh slot and different from the sixth slot. A second parallel conductor portion of the sixth conductor (600) is configured to be inserted into a ninth slot of the plurality of slots adjacent to the eighth slot and different from the seventh slot. The overhang portion of the fourth conductor (400) comprises a third U-bend portion in a direction perpendicular to a plane defined by the two parallel conductor portions, the third U-bend portion being formed so as to accommodate a traversing part of the overhang portion of the fifth conductor (500) and a traversing part of the overhang portion of the sixth conductor (600). The overhang portion of the fifth conductor (500) comprises a fourth U-bend portion in a direction perpendicular to a plane defined by the two parallel conductor portions, the fourth U-bend portion being formed so as to accommodate a traversing part of the overhang portion of the sixth conductor (600) The overhang portion of the sixth conductor (600) is contained within a plane defined by the two parallel conductor portions.

In this manner, a winding with a plurality of layers may be created.

According to another preferred embodiment, the winding further comprises a step deformation conductor (700) comprising two parallel conductor portions (710, 720) connected by an overhang portion, wherein a first parallel conductor portion (710) of the step deformation conductor (700) is configured to be inserted into a tenth slot of the plurality of slots and a second parallel conductor portion (720) of the step deformation conductor (700) is configured to be inserted into a thirteenth slot separated by two slots from the tenth slot. The first parallel conductor portion (710) of the step deformation conductor (700) is arranged in a first layer of the winding and the second parallel conductor portion (720) of the step deformation conductor (700) is arranged in a second layer of the winding adjacent to the first layer. The overhang portion of the step deformation conductor (700) comprises an extension portion (740) connected to, and possibly collinear with, the first parallel conductor portion (710), a first curved portion (750) connected to the first straight portion (740), a diagonal portion (760), a second curved portion (770) connecting the diagonal portion (760) and the second parallel conductor portion (720), and an S-shaped portion (790) connecting the first curved portion (750) arranged in the first layer to the diagonal portion (760) arranged in the second layer.

In this manner, conductors in two adjacent layers can be connected electrically.

According to another preferred embodiment, the winding further comprises a first coil contact conductor (800), a second coil contact conductor (900), a third coil contact conductor (1000), each of the first coil contact conductor (800), the second coil contact conductor (900) and the third coil contact conductor (1000) comprising a parallel conductor portion (820, 920, 1020) connected to an overhang portion (830, 930, 1030), the parallel conductor portions (820, 920, 1020) being arranged in a third layer of the winding. Each of the overhang portions (830, 930, 1030) of the first, the second, and the third coil contact conductor (800, 900, 1000) comprises an extension portion (840, 940, 1040) arranged in a fourth layer of the winding adjacent to the third layer and protruding from the winding, a first curved portion (850, 950, 1050) connected to the extension portion (840, 940, 1040), a diagonal portion (860, 960, 1060) connected to the first curved portion (850, 950, 1050), and a second curved portion (870, 970, 1070) connecting the diagonal portion (860, 960, 1060) and the parallel conductor portion (820, 920, 1020). The parallel conductor portion (820) of the first coil contact conductor (800) is configured to be inserted into the fourth slot, the parallel conductor portion (920) of the second coil contact conductor (900) is configured to be inserted into the fifth slot, and the parallel conductor portion (1020) of the third coil contact conductor (1000) is configured to be inserted into the sixth slot. The extension portion (840) of the first coil contact conductor (800) is in contact with a fourth coil contact conductor (1100), the fourth coil contact conductor (1100) being connected to, and possibly collinear with, a parallel conductor portion arranged in the third layer of the winding in the first slot. The extension portion (940) of the second coil contact conductor (900) is in contact with a fifth coil contact conductor (1200), the fifth coil contact conductor (1200) being connected to, and possibly collinear with, a parallel conductor portion arranged in the third layer of the winding in the second slot. The extension portion (1040) of the third coil contact conductor (1000) is in contact with a sixth coil contact conductor (1300), the sixth coil contact conductor (1300) being connected to, and possibly collinear with, a parallel conductor portion arranged in the third layer of the winding in the third slot. The diagonal portion (860, 960, 1060) of each of the first, the second and the third coil contact conductor (800, 900, 1000) comprises an S-shaped portion (890, 990, 1090) arranged between the third layer and the fourth layer so that both the fifth and the sixth coil contact conductor (1200, 1300) traverse the diagonal portion (860) of the first coil contact conductor (800) and that the sixth coil contact conductor (1300) traverses the diagonal portion (960) of the second coil contact conductor (900).

In this manner, an electric connection or tap may be created for each conductor of the winding.

Preferably, a ratio of a tooth width of the stator or rotor and a thickness of the conductor is greater than 1.5. Moreover, an axial length of the overhang portions may be equal to

$$o = \frac{4 * w + 3 * s}{1.8}$$

wherein w is a width of the conductors and s is the tooth width of the stator or rotor.

According to a second aspect of the invention, an electric machine is provided. The electric machine comprises a stator with a plurality of slots and a winding as described above.

According to a third aspect of the invention, a method for manufacturing a winding for an electric machine is provided. This method comprises the steps of wire forming a first conductor (100), a second conductor (200), and a third conductor (300), each of the first conductor (100), the second conductor (200) and the third conductor (300) comprising two parallel conductor portions connected by an overhang portion, and inserting the first conductor (100), the second conductor (200) and the third conductor (300) in the stated order into a plurality of slots of a rotor or a stator of the electric machine. Said steps are performed such that a first parallel conductor portion of the first conductor (100) is inserted into a first slot of the plurality of slots, a first parallel conductor portion of the second conductor (200) is inserted into a second slot of the plurality of slots adjacent to the first slot, a first parallel conductor portion of the third conductor (300) is inserted into a third slot of the plurality of slots adjacent to the second slot and different from the first slot, a second parallel conductor portion of the first conductor (100) is inserted into a fourth slot of the plurality of slots adjacent to the third slot and different from the first slot, the second slot, and the third slot, a second parallel conductor portion of the second conductor (200) is inserted into a fifth slot of the plurality of slots adjacent to the fourth slot and different from the third slot, and a second parallel conductor portion of the third conductor (300) is inserted into a sixth slot of the plurality of slots adjacent to the fifth slot and different from the fourth slot. Moreover, the wire forming is performed such that the overhang portion of the first conductor (100) comprises a first U-bend portion (190) in a direction perpendicular to a plane defined by the two parallel conductor portions (110, 120), the first U-bend portion (190) being formed so as to accommodate a traversing part of the overhang portion (230) of the second conductor (200) and a traversing part of the overhang portion (330) of the third conductor (300), the overhang portion of the second conductor (200) comprises a second U-bend portion (290) in a direction perpendicular to a plane defined by the two parallel conductor portions (210, 220), the second U-bend portion (290) being formed so as to accommodate a traversing part of the overhang portion (330) of the third conductor (300), and the overhang portion (330) of the third conductor (300) is contained within a plane defined by the two parallel conductor portions (310, 320).

### BRIEF DESCRIPTION OF DRAWINGS

The present invention is illustrated by way of example, and not by way of limitation, in the figures of the accompanying drawings and in which like reference numerals refer to similar elements and in which:

FIG. 1 is a schematic drawing illustrating a portion of a stator with windings, according to an embodiment of the present invention;

FIG. 2A is a schematic drawing illustrating an overhang portion of a conductor for a first phase of a three-phase electric machine, according to an embodiment of the present invention;

FIG. 2B is a schematic drawing illustrating an overhang portion of a conductor for a second phase of a three-phase electric machine, according to an embodiment of the present invention;

FIG. 2C is a schematic drawing illustrating an overhang portion of a conductor for a third phase of a three-phase electric machine, according to an embodiment of the present invention;

FIG. 3A is a schematic drawing illustrating the geometry of the overhang of a winding for a three-phase electric machine, according to an embodiment of the present invention;

FIG. 3B is a schematic drawing illustrating the winding geometry for a three-phase electric machine, according to an embodiment of the present invention;

FIG. 4A is a schematic drawing illustrating two layers of an overhang of a winding for a three-phase electric machine, according to an embodiment of the present invention;

FIG. 4B is a schematic drawing illustrating three layers of an overhang of a winding for a three-phase electric machine, according to an embodiment of the present invention;

FIG. 4C is a schematic drawing illustrating six layers of an overhang of a winding for a three-phase electric machine, according to an embodiment of the present invention;

FIG. 5A is a schematic drawing illustrating a step deformation for a conductor for a three-phase electric machine, according to an embodiment of the present invention;

FIG. 5B is a schematic drawing illustrating the step deformation for all three conductors for a three-phase electric machine, according to an embodiment of the present invention;

FIG. 5C is another schematic drawing illustrating the step deformation of FIG. 5B;

FIG. 6A is a schematic drawing illustrating an contact portion of a conductor for a first phase of a three-phase electric machine, according to an embodiment of the present invention;

FIG. 6B is a schematic drawing illustrating an contact portion of a conductor for a second phase of a three-phase electric machine, according to an embodiment of the present invention;

FIG. 6C is a schematic drawing illustrating an contact portion of a conductor for a third phase of a three-phase electric machine, according to an embodiment of the present invention;

FIG. 7A is a schematic drawing illustrating the contact portion for all conductors within one layer of a three-phase electric machine, according to an embodiment of the present invention;

FIG. 7B is a schematic drawing illustrating the contact portion for all conductors within two layers of a three-phase electric machine, according to an embodiment of the present invention;

FIG. 7C is another schematic drawing illustrating the contact portion of FIG. 7B;

FIG. 8 is a schematic drawing illustrating alternative configurations of the overhang portion, according to various embodiments of the present invention;

FIG. 9 is a schematic drawing illustrating the configuration of the overhang portion for a six-phase electric machine, according to another embodiment of the present invention.

### DETAILED DESCRIPTION

The present invention is disclosed in connection with an inner-stator type of synchronous electric machine with permanent magnets, but is not limited to this particular type of machine and can also be implemented for other types, such as an outer-stator or any other induction machine or other kind of machine. The present invention can also be used for linear actuators of linear machines, wherein the active part of the machine is outstretched into the straight section of the end length. Moreover, the described topological and constructional solutions of the winding can be implemented in the stator or rotor of the motor. For the sake of simplicity, the invention is presented for a stator winding, and in particular for the inner stator 3-phase permanent magnet synchronous motor type used in the applicant's in-wheel electric motor.

A winding for an electric machine according to the present invention may comprise several turns for several phases. In the following, the geometry of the winding is predominantly explained in the context of a three-phase motor. The invention, however, is not limited to three-phase electric machines and can also be applied to machines with four, five, six, or any other integer number of phases.

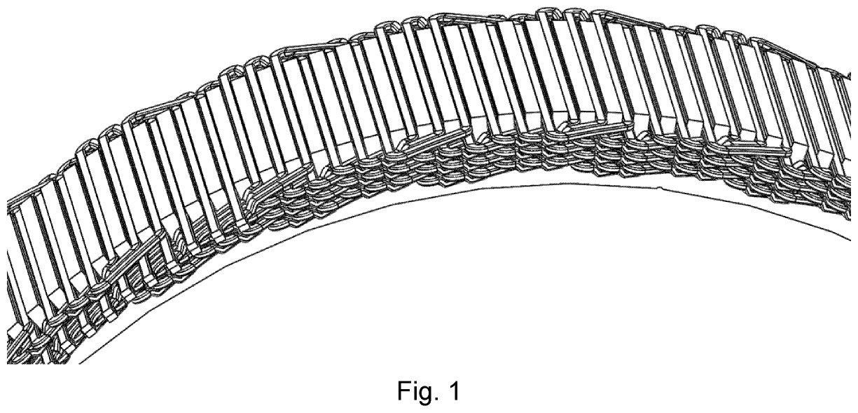

FIG. 1 is a schematic drawing illustrating a portion of a stator with windings, according to an embodiment of the present invention. Each turn of a winding coil consists of a straight portion of the conductor arranged within one of the stator slots and a bent overhang bringing the wire from one side of the coil to the other side. As the same-phase windings are electrically connected in series, they are part of the same conductor weaving from one coil to the next. The overhangs intersect in a plane, i.e. they physically interfere as the wires cross each other. In order to solve the problem of manufacturing such a construction, the present invention provides a well-defined path for the conductors so that the windings can be packed in the desired form. Additionally, when the next layer is added for the next winding turn, the in-slot portion of the conductors must fit on top of the previous layer without any vertical space in between. The present invention thus provides a winding geometry with triangular overhangs that allows the straight conductors of each wiring turn to be arranged within one plane of the layer while conductors of consecutive turns may simply be stacked on top of each other without any space between this and the next layer.

According to the particular approach of the present invention, N types of conductor are used for creating a winding for an N-phase electric machine. The N types of conductor only differ with regard to the shape of their overhang. While the overhang portion of each conductor substantially consists of a 180° U-turn in order to return the current from the straight conductor portion in one stator slot to the oppositely oriented straight portion in the next stator slot, all but one of these overhang portions also comprise a U-bent portion in the radial direction that is formed so as to facilitate crossing with one or more conductors for the other phases. The width of these U-bent portions is adapted for the conductors of each phase, so that the U-bent portion of the conductor for the i-th phase can accommodate a portion of each conductor for the (i+1)-th, (i+2)-th, . . . , N-th phase. The overhang portion for N-th phase, on the other hand, is substantially restricted to the radial layer of the respective turn and has no U-bent portion in the radial direction.

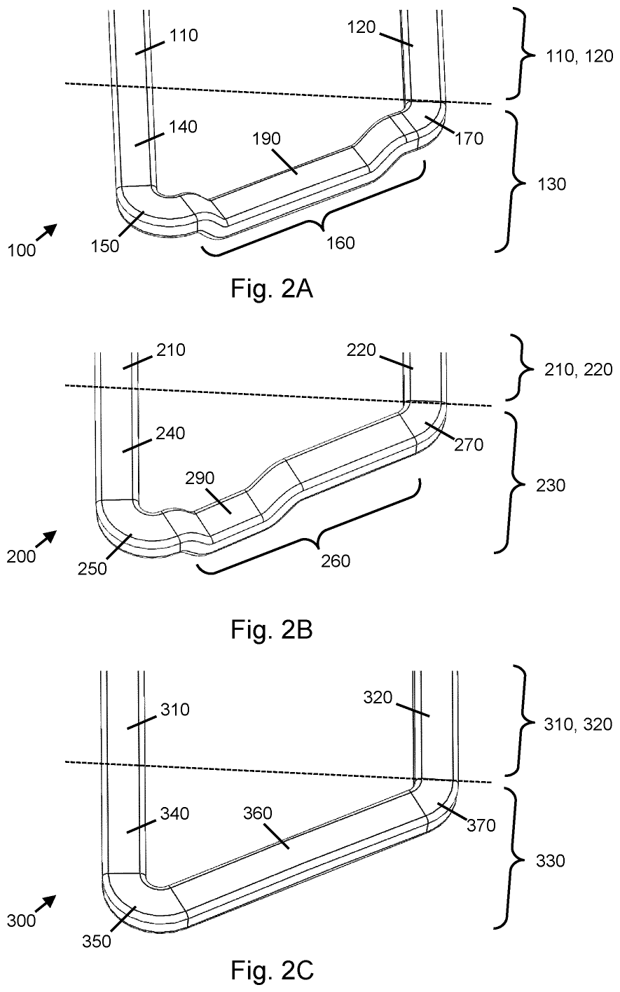

This general concept is illustrated in FIGS. 2-6 for an example three-phase electric machine.

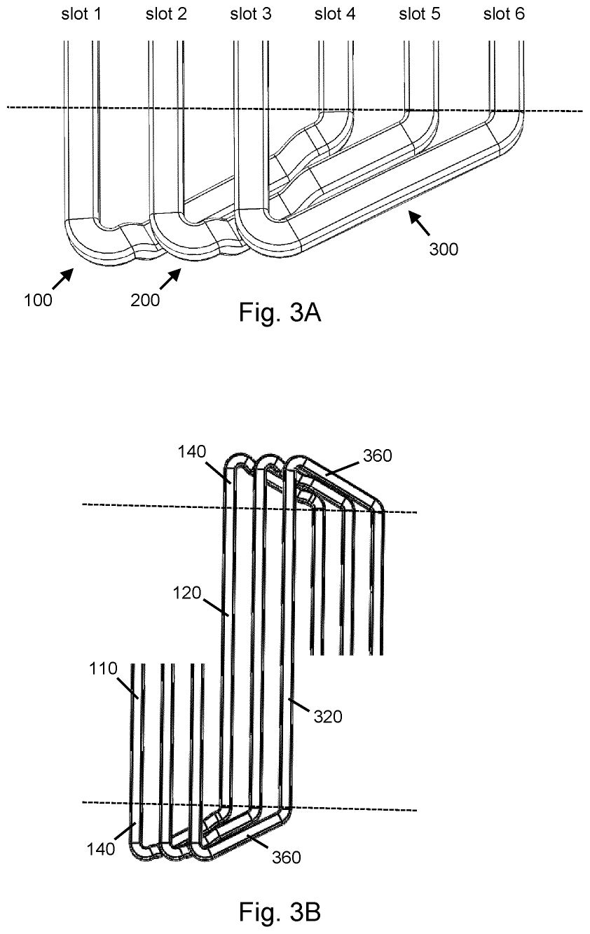

FIGS. 2A to 2C illustrate an overhang portion of a conductor for a first phase, a second phase, and a third phase, respectively, of a three-phase electric machine, according to an embodiment of the present invention. FIG. 3A shows how the three differently shaped conductors interact when inserted into the respective stator slots. FIG. 3B is a top view of the straight conductor portions connected by an overhang at both sides of the stator. The wire overhangs on both sides are mirror images along the length of the wave winding.

As can be seen, the two straight conductor portions (110, 120) of the conductor (100) for the first phase are connected by an overhang portion (130) that is provided with a U-bent portion (190) that is wide enough to accommodate traversing portions of the conductors (200, 300) for the second phase and the third phase. The conductor (200) for the second phase has a similar configuration, except that the U-bent portion (290) is narrower, since it needs to accommodate a traversing portion of the conductor for the third phase only. The conductor (300) for the third phase, on the other hand, is flat and has no U-bent in the radial direction.

In the three-phase system, the wide U-bend (190) is placed at the long arm (160) of the triangular overhang (130). It is a step deformation forming a through with a depth of the conductor thickness. There are two such steps, left and right. The step deformation is preferably stretched over the whole width of the stator tooth providing for the least aggressive deformations regarding the isolation stress. The width of the through in double U-bend (the flat space (190) between the left and right steps) must accommodate the straight sections of the other two overhangs coming out from the next two stator slots. In the case of the conductor (100) for the first phase, the through (190) needs to extend over the whole stator pitch plus the one slot width.

The narrow U-bend (290) is similar to the wide U-bend (190). It is also placed at the long arm (260) of the overhang. The left and right steps are identical as above, stretching over the whole stator tooth width. The difference is in the width of the through (290).

The flat overhang (330) has no U-bent portion and simply delivers the conductor to the next coil side in the same layer.

The wire is inserted into the stator slots in layers. Each layer corresponds to one turn of the winding. The number of layers is thus equal to the number of turns. A complete winding turn consists of two parallel conductors placed inside the stator slots and corresponding overhangs outside the stator slot. Radially, the height of the layer is twice the wire height. The height of the overhangs is equal to (M+1) times the height of the wire, wherein M is the number of layers. The winding stays compact while cascaded into an arbitrary number of turns (layers).

In this embodiment, the overhangs stretch out for three times the wire width, which is a geometrically minimal overhang. If the stator pitch is wider, the vertex angle of the overhangs gets wider. If the stator pitch is narrower the vertex angle of the overhangs gets sharper. Thus, the winding can easily be scaled to different stator slot/pitch geometries.

The conductors are placed in the stator core slots in the following sequence: The conductor with the wide U-bend overhang is placed first. The second conductor with the narrow U-bend overhang is placed into the right neighbouring slot of the first conductor and the third conductor with a flat overhang is placed in the next right neighbouring slot of the second conductor. Obviously, the winding can be wound in any direction, clockwise or counter-clockwise. The wire shape and the assembly sequence ensure that there is no interference between the conductors, as shown in FIG. 3A.

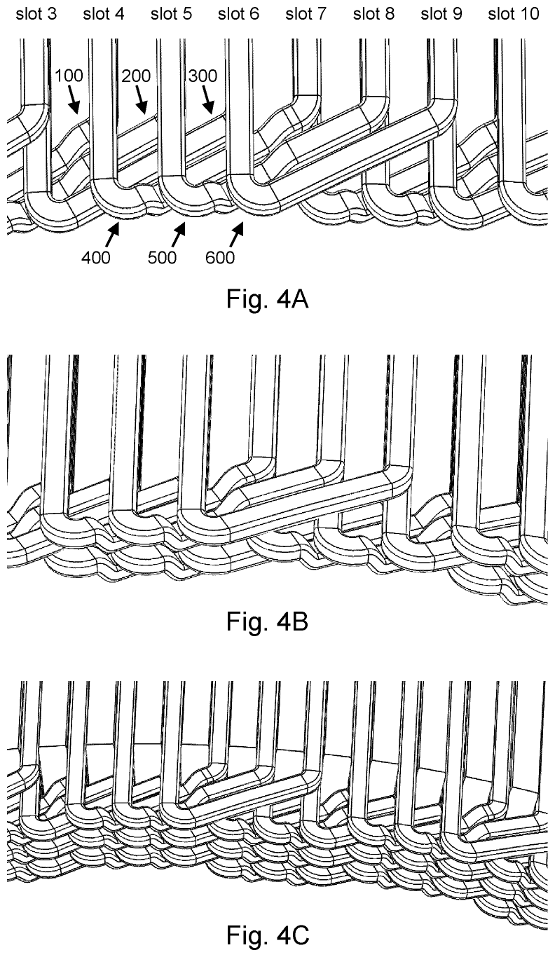

FIG. 4A illustrates how conductors (400, 500, 600) for the three phases of a second layer are stacked onto the conductors (100, 200, 300) for the three phases of a first layer. FIG. 4B illustrates three layers of an overhang of a winding for a three-phase electric machine, whereas FIG. 4C shows an example with six layers.

As can be seen, the next layer of conductors is shifted three slots relative to the first layer and the conductors are placed in the slots in the same sequence as the first layer. The third layer is placed on top of the second layer and the winding overhangs are aligned with the first layer. Each layer alternates the shift of conductors in this sequence.

It goes without saying that the present invention is not limited to windings with only two, three or six layers, as shown in FIGS. 4A-4C. Instead any number of layers may be used, depending on requirements. Moreover, the terms “first layer”, “second layer”, etc. do not imply that the respective layer is the first layer (i.e. the innermost layer) or the second layer (i.e. the layer ontop of the “first layer”) within a winding. Instead, said terms are used as a placeholder for any layer within a multilayer winding, unless explicitly stated otherwise. The same applies also to the terms “first slot”, “second slot”, etc., which are to be understood as placeholders for any slot of a multi-slot stator. Unless stated otherwise, the “second slot” and the “third slot” are not necessarily the slots that follow the “first slot” according to a certain scheme for consecutively numbering the slots of the stator. Hence, the slots referred to as “first slot”, “second slot”, etc. are also not limited to the slots marked as “slot 1”, “slot 2”, etc. in the figures.

To be able to assemble arbitrary windings regarding the combination of conductors connected in series or parallel, two additional features are provided: stepping the winding from one layer to the next layer with a continuous wire, and cutting the wires while providing for the wire extensions for contacts being able to continue the wiring in the same layer or the next layer.

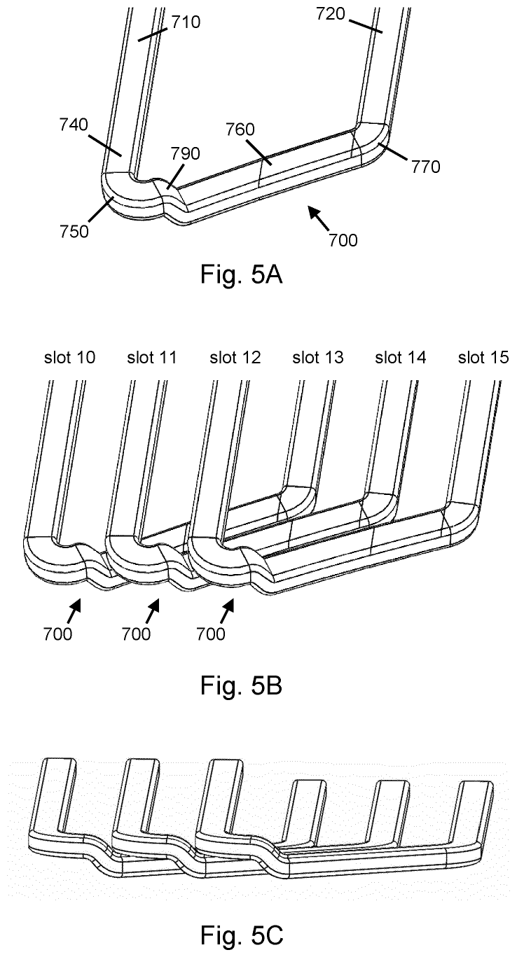

The step deformation required for connecting the conductors in two adjacent layers is illustrated in FIGS. 5A-5C. The step deformation has the same shape for all three phases. The overhang steps from one layer to the next in one step. This type of deformation can be used for all deformations, including hairpin windings.

In order to provide electric contacts to the winding, the wire needs to protrude from the winding to make space for brazing. According to the present invention, this is achieved by providing contact portions for the conductors of each phase.

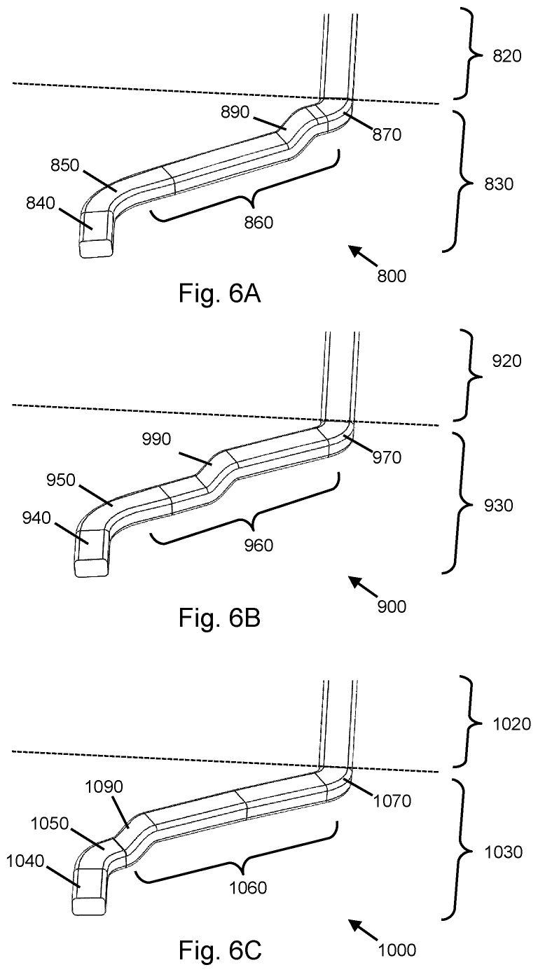

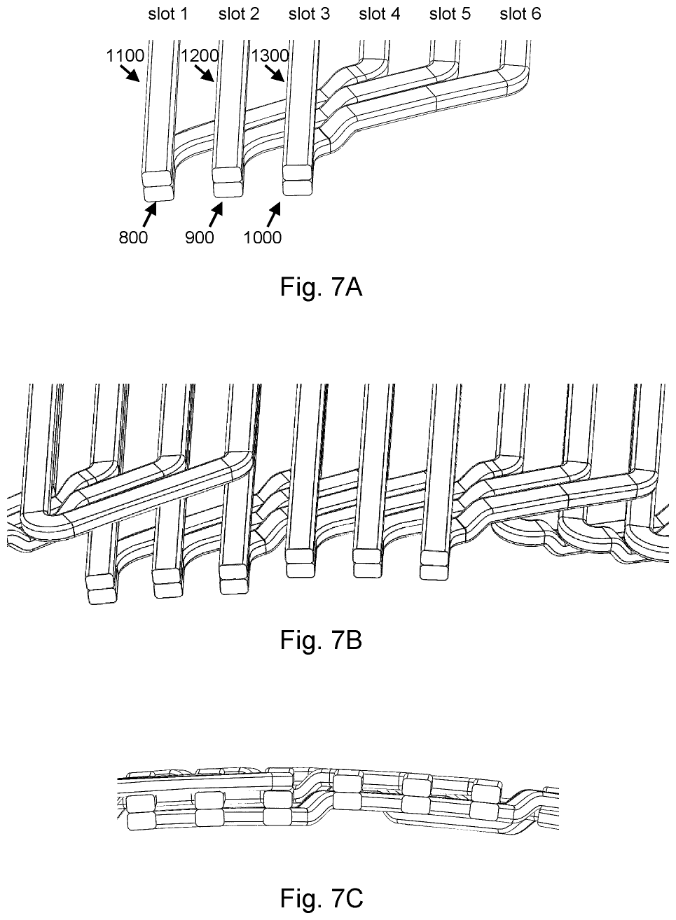

FIGS. 6A to 6C show contact portions of the conductors for the three phase of a three-phase electric machine, respectively. The interaction of the three contact portions within one layer of a three-phase electric machine, is shown in FIG. 7A. FIG. 7B illustrates the contact portion for all conductors within two layers of a three-phase electric machine, and FIG. 7C is a side view of the configuration shown in FIG. 7B.

With this geometry, it is a quite straightforward solution since the wires are not interlaced.

Geometrically speaking the wire is cut at the overhang vertex and a bit of wire stretching out of the stator coils provides the space for brazing or other means of electrical contacts. In the case of the overhangs with a wide U-bent portion (190) and a narrow U-bent portion (290), the step near the vertex (150, 250) is omitted and the wire (840, 940, 1040) is stretched out of the winding, while the flat overhang gains one step-down at the vertex. In this manner, all three wires are brought out of the winding one layer below. As shown in FIG. 7A the winding is continued in the same layer simply by stretching the straight in-slot portion (1010, 1020, 1030) of the continuing conductors.

By properly arranging the wire cuts and layer oversteps, a stator can be assembled with any desired combination of either coil turns or conductor cross-section i.e., parallel conductors. The contacts can be distributed suitably along the stator circumference for easier accessibility of the wire-ends for making the electrical connections.

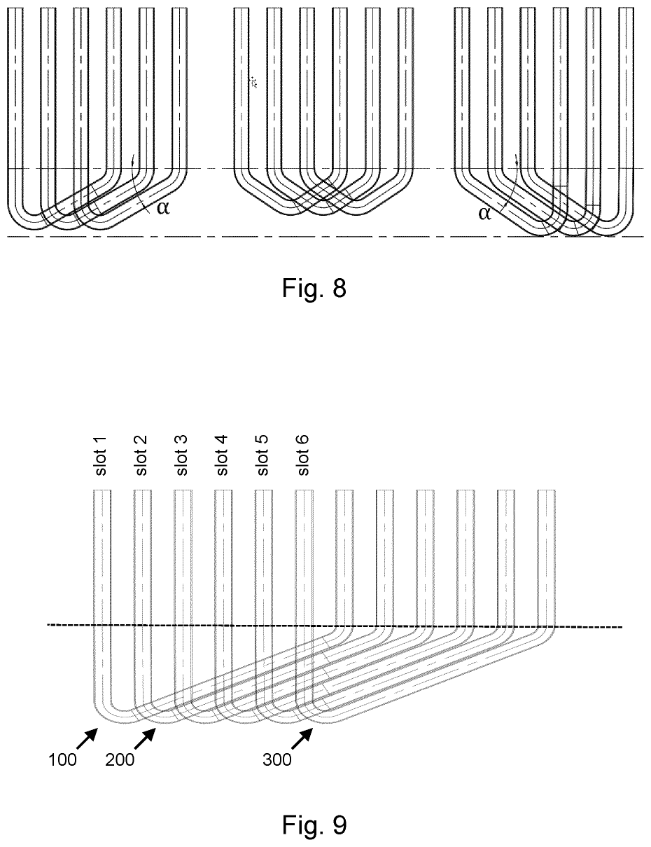

The configuration of the overhangs shown in FIGS. 1-7 is based on a skewed triangle. The invention, however, can also be implemented with differently shaped triangles, including a left skewed triangle, a symmetrical triangle, and a right skewed triangle, as illustrated in FIG. 8.

The form of the overhang portion, and in particular the U-bent portion, may only be limited by the wire width, wire height and stator teeth dimensions. The reason is that very thick wires need more space for bending. Empirically, the ratio between the stator tooth width and the wire thickness should be at least 1.5.

The characterizing parameter of the winding geometry is the angle α shown in FIG. 8, at which the wires exit the stator slots and enter the overhang. There exists a minimum angle at which the wires are packed close together. The angle α at which the wires are packed is larger or equal:

α≥arcsin((w+δ)/(s+w)),

where w is the wire width and is considered here to be equal to the stator slot, s is the width of the stator tooth, so that (s+w) is the stator pitch. For different embodiments, this angle can vary from this minimal angle to 90 degrees. The parameter δ is a width correction that is used to provide some space between the wires which is needed because U-bends cannot be bent at zero radii. As the overhang vertex is moved from left to right, different embodiments are obtained. In this disclosure, the exemplary embodiment is the right-hand right triangle.

The left-hand wire exits the slot straight out forming a right triangle. By forming a smaller exit angle, the overhang vertex moves toward the middle point, where both angles are equal to a and the overhang forms almost an isosceles triangle. By moving the vertex more to the right, the exit angle of the right-hand wire will eventually reach full 90 degrees forming the right-hand overhang. The angle α at which the wires are densely packed moves to the other side. An optimum geometry concerning the overhang is close to the middle when the overhang forms the isosceles triangle.

The U-bends need to accommodate crossings of the remaining wires. This winding geometry can be used for any number of phases. In the exemplary embodiment (left-hand right triangle) for any phase wire i=1, . . . , (N−1) the corresponding U-bend should extend over the distance d along the wire:

$$\begin{matrix}d * cos ( α ) = ( N - i - 1 ) * ( s + w ) + w ; & i ∈ \{ 1 , … , N - 1 \} \\ d = 0 ; & i = N ,\end{matrix}$$

where N is the number of phases, and i is the i-th phase wire. The last phase wire is flat (i=N). Here too, considering that wires cannot be bent over a zero radius, this distance along the wire would be a bit longer and can be obtained from a 3D model of the winding.

For the three-phase system, three types of deformations are needed to pack the overhangs of each winding turn: a wide U-bent portion, a narrow U-bent portion and the flat overhang as is illustrated in FIGS. 2A-2C. The next layer is shifted circumferentially (in the layer plane) so that the overhangs of the next layer drop in and the parallel in-slot portion of conductors fits on top of the previous layer without any space being lost in between layers or blowing of the winding at the overhangs.

The geometry disclosed can be applied also to so-called double coil span windings where the number of wires would be 2*N.

A geometric limitation may arise from the space required for the U-bent portion to accommodate the traversing portion of the other winding conductors. The placing of the wires in three sequential loops for three phases is possible as long as the long arm of the triangle has the length to accommodate the wide U-bent portion with two-wire crossings.

Moreover, the invention is not limited to windings for a three-phase electric machine, but may be implemented for an arbitrary number of phases, including 4, 5, 6 or even more phases.

FIG. 9 illustrates the configuration of the overhang portion for a six-phase electric machine, according to another embodiment of the present invention. As can be seen, differently shaped conductors are provided for each phase, wherein all but one conductors are provided with a U-bent portion for accommodating a traversing portion of at least one of the other conductors. In this example, the conductor (100) for the first phase is provided with a wide U-bent portion for accommodating a traversing portion of each of the other conductors. The conductor (200) for the second phase has a U-bent portion that is not as wide as the first conductor (100) because only the third to sixth conductors need to be accommodated. The conductor (300) for the last phase, finally, is substantially flat.

The present invention thus provides a winding for an electric machine that is compact and has a low resistance and leakage inductance due to short wiring. Moreover, a large number of turns can be realized by simply stacking a plurality of preformed conductors on top of each other while keeping a high slot fill ratio.

Further, the wiring pattern according to the present invention lends itself to easy manufacturing because each linear segment of each layer is located at the same radial distance from the central axis of the stator core, and therefore the stator windings are not interlaced because they do not alternate between the rear and front positions with other conductors in the slot. Each end loop segment advantageously forms a cascaded winding pattern. The complex interlacing winding process of the prior art is thus not required. Instead, preformed conductors may simply be inserted one by one into the stator slots. This allows for a particularly simple machine for fast and safe wire insertion, thus enabling mass production. At the same time, a high degree of flexibility is maintained and different types of motors with different numbers of layers of conductors and winding topologies can be produced. Using only a limited number of differently shaped conductors provides benefits in the construction of the wire shaping tools so that multiple wire overhangs can be shaped simultaneously.

Summarizing, the present invention provides a compact winding for multi-phase electric machines. For each phase, a conductor with a specifically shaped overhang portion is provided. All but one of the various overhang portions are provided with a U-bent portion to accommodate a traversing portion of at least one of the other conductors. The width of the U-bent portions differs from phase to phase so that conductors can be inserted into the stator slots in a staggered fashion. A step deformation which has the same shape for all phases, is used for connecting different layers of the winding. Electric contacts to the windings are provided at the overhang portions without deviating from the staggered arrangement of traversing conductor portions.

1. A winding for an electric machine, comprising:
a first conductor, a second conductor, and a third conductor, each of the first conductor, the second conductor, and the third conductor comprising two parallel conductor portions connected by an overhang portion;
wherein a first parallel conductor portion of the first conductor is configured to be inserted into a first slot of a plurality of slots of a rotor or a stator of the electric machine;
wherein a first parallel conductor portion of the second conductor is configured to be inserted into a second slot of the plurality of slots adjacent to the first slot;
wherein a first parallel conductor portion of the third conductor is configured to be inserted into a third slot of the plurality of slots adjacent to the second slot and different from the first slot;
wherein a second parallel conductor portion of the first conductor is configured to be inserted into a fourth slot of the plurality of slots different from the first slot, the second slot, and the third slot;
wherein a second parallel conductor portion of the second conductor is configured to be inserted into a fifth slot of the plurality of slots adjacent to the fourth slot and different from the third slot;
wherein a second parallel conductor portion of the third conductor is configured to be inserted into a sixth slot of the plurality of slots adjacent to the fifth slot and different from the fourth slot;
the overhang portion of the first conductor comprising a first U-bend portion in a direction perpendicular to a plane defined by the two parallel conductor portions, the first U-bend portion being formed so as to accommodate a traversing part of the overhang portion of the second conductor and a traversing part of the overhang portion of the third conductor;
the overhang portion of the second conductor comprising a second U-bend portion in a direction perpendicular to a plane defined by the two parallel conductor portions, the second U-bend portion being formed so as to accommodate a traversing part of the overhang portion of the third conductor; and
the overhang portion of the third conductor is being contained within a plane defined by the two parallel conductor portions.

2. The winding for the electric machine according to claim 1, wherein the first conductor, the second conductor, and the third conductor correspond to a first phase of the winding, a second phase of the winding, and a third phase of the winding, respectively.

3. The winding for the electric machine according to claim 2, wherein said winding has a total of three phases and the fourth slot is adjacent to the third slot.

4. The winding for the electric machine according to claim 2, wherein said winding has a total of N phases, N being an integer greater than 3, and the fourth slot is arranged N−3 slots apart from to the third slot.

5. The winding for the electric machine according to claim 1, wherein a width of the first U-bend portion corresponds to a pitch of the plurality of slots plus a width of one of the plurality of slots, and wherein a width of the second U-bend portion corresponds to the width of one of the plurality of slots.

6. The winding for the electric machine according to claim 1, wherein each of a depth of the first U-bend portion and a depth of the second U-bend portion corresponds to a width of the third conductor in a direction perpendicular to the plane defined by the two parallel conductor portions.

7. The winding for the electric machine according to claim 1, wherein each of the overhang portions of the first, the second, and the third conductor comprises an extension portion connected to the first parallel conductor portion, a first curved portion connected to the extension portion, a diagonal portion connected to the first curved portion, and a second curved portion connecting the diagonal portion and the second parallel conductor portion,
wherein the first U-bend portion is arranged in the diagonal portion of the overhang portion of the first conductor and the second U-bend portion is arranged in the diagonal portion of the overhang portion of the second conductor.

8. The winding for the electric machine according to claim 7, wherein the extension portion of each of the overhang portions of the first, the second, and the third conductor has a length that allows the overhang portion of the third conductor to traverse the first U-bend portion in the overhang portion of the first conductor and the second U-bend portion in the overhang portion of the second conductor.

9. The winding for the electric machine according to claim 7,
wherein the first U-bend portion is formed such that its trough accommodates the extension portion of the second conductor and the extension portion of the third conductor;
wherein the second U-bend portion is formed such that its trough accommodates the extension portion of the third conductor; and
wherein a trough in the first U-bend portion is wider than a trough in the second U-bend portion.

10. The winding for the electric machine according to claim 1, wherein each of the first, the second, and the third conductor further comprises a plurality of parallel conductor portions serially connected by a plurality of overhang portions.

11. The winding for the electric machine according to claim 1, further comprising:
a fourth conductor, a fifth conductor, and a sixth conductor, each of the fourth conductor, the fifth conductor and the sixth conductor comprising two parallel conductor portions connected by an overhang portion;
wherein a first parallel conductor portion of the fourth conductor is configured to be inserted into the fourth slot on top of the second parallel conductor portion of the first conductor;
wherein a first parallel conductor portion of the fifth conductor is configured to be inserted into the fifth slot on top of the second parallel conductor portion of the second conductor;
wherein a first parallel conductor portion of the third conductor is configured to be inserted into the sixth slot on top of the second parallel conductor portion of the third conductor;
wherein a second parallel conductor portion of the fourth conductor is configured to be inserted into a seventh slot of the plurality of slots adjacent to the sixth slot and different from the fifth slot;
wherein a second parallel conductor portion of the fifth conductor is configured to be inserted into an eighth slot of the plurality of slots adjacent to the seventh slot and different from the sixth slot;
wherein a second parallel conductor portion of the sixth conductor is configured to be inserted into a ninth slot of the plurality of slots adjacent to the eighth slot and different from the seventh slot;
wherein the overhang portion of the fourth conductor comprises a third U-bend portion in a direction perpendicular to a plane defined by the two parallel conductor portions, the third U-bend portion being formed so as to accommodate a traversing part of the overhang portion of the fifth conductor and a traversing part of the overhang portion of the sixth conductor;
wherein the overhang portion of the fifth conductor comprises a fourth U-bend portion in a direction perpendicular to a plane defined by the two parallel conductor portions, the fourth U-bend portion being formed so as to accommodate a traversing part of the overhang portion of the sixth conductor; and
wherein the overhang portion of the sixth conductor is contained within a plane defined by the two parallel conductor portions.

12. The winding for the electric machine according to claim 1, further comprising:
a step deformation conductor comprising two parallel conductor portions connected by an overhang portion,
wherein a first parallel conductor portion of the step deformation conductor is configured to be inserted into a tenth slot of the plurality of slots and a second parallel conductor portion of the step deformation conductor is configured to be inserted into a thirteenth slot separated by two slots from the tenth slot;
wherein the first parallel conductor portion of the step deformation conductor is arranged in a first layer of the winding and the second parallel conductor portion of the step deformation conductor is arranged in a second layer of the winding adjacent to the first layer; and
wherein the overhang portion of the step deformation conductor comprises an extension portion connected to the first parallel conductor portion, a first curved portion connected to the first straight portion, a diagonal portion, a second curved portion connecting the diagonal portion and the second parallel conductor portion, and an S-shaped portion connecting the first curved portion arranged in the first layer to the diagonal portion arranged in the second layer.

13. The winding for the electric machine according to claim 1, further comprising:
a first coil contact conductor, a second coil contact conductor, a third coil contact conductor, each of the first coil contact conductor, the second coil contact conductor and the third coil contact conductor comprising a parallel conductor portion connected to an overhang portion, the parallel conductor portions being arranged in a third layer of the winding,
wherein each of the overhang portions of the first, the second, and the third coil contact conductor comprises an extension portion arranged in a fourth layer of the winding adjacent to the third layer and protruding from the winding, a first curved portion connected to the extension portion, a diagonal portion connected to the first curved portion, and a second curved portion connecting the diagonal portion and the parallel conductor portion;
wherein the parallel conductor portion of the first coil contact conductor is configured to be inserted into the fourth slot, the parallel conductor portion of the second coil contact conductor is configured to be inserted into the fifth slot, and the parallel conductor portion of the third coil contact conductor is configured to be inserted into the sixth slot;
wherein the extension portion of the first coil contact conductor is in contact with a fourth coil contact conductor, the fourth coil contact conductor being connected to a parallel conductor portion arranged in the third layer of the winding in the first slot;
wherein the extension portion of the second coil contact conductor is in contact with a fifth coil contact conductor, the fifth coil contact conductor being connected to a parallel conductor portion arranged in the third layer of the winding in the second slot;
wherein the extension portion of the third coil contact conductor is in contact with a sixth coil contact conductor, the sixth coil contact conductor being connected to a parallel conductor portion arranged in the third layer of the winding in the third slot; and
wherein the diagonal portion of each of the first, the second and the third coil contact conductor comprises an S-shaped portion arranged between the third layer and the fourth layer so that both the fifth and the sixth coil contact conductor traverse the diagonal portion of the first coil contact conductor and that the sixth coil contact conductor traverses the diagonal portion of the second coil contact conductor.

14. An electric machine, comprising
a stator with a plurality of slots; and
a winding comprising a first conductor, a second conductor, and a third conductor, each of the first conductor, the second conductor, and the third conductor comprising two parallel conductor portions connected by an overhang portion;
wherein a first parallel conductor portion of the first conductor is configured to be inserted into a first slot of the plurality of slots of the stator of the electric machine;
wherein a first parallel conductor portion of the second conductor is configured to be inserted into a second slot of the plurality of slots adjacent to the first slot;
wherein a first parallel conductor portion of the third conductor is configured to be inserted into a third slot of the plurality of slots adjacent to the second slot and different from the first slot;
wherein a second parallel conductor portion of the first conductor is configured to be inserted into a fourth slot of the plurality of slots different from the first slot, the second slot, and the third slot;
wherein a second parallel conductor portion of the second conductor is configured to be inserted into a fifth slot of the plurality of slots adjacent to the fourth slot and different from the third slot;
wherein a second parallel conductor portion of the third conductor is configured to be inserted into a sixth slot of the plurality of slots adjacent to the fifth slot and different from the fourth slot;
the overhang portion of the first conductor comprising a first U-bend portion in a direction perpendicular to a plane defined by the two parallel conductor portions, the first U-bend portion being formed so as to accommodate a traversing part of the overhang portion of the second conductor and a traversing part of the overhang portion of the third conductor;
the overhang portion of the second conductor comprising a second U-bend portion in a direction perpendicular to a plane defined by the two parallel conductor portions, the second U-bend portion being formed so as to accommodate a traversing part of the overhang portion of the third conductor; and
the overhang portion of the third conductor being contained within a plane defined by the two parallel conductor portions.

15. A method for manufacturing a winding for an electric machine, said method comprising the steps of:
wire forming a first conductor, a second conductor, and a third conductor, each of the first conductor, the second conductor and the third conductor comprising two parallel conductor portions connected by an overhang portion,
inserting the first conductor, the second conductor and the third conductor in the stated order into a plurality of slots of a rotor or a stator of the electric machine such that:
a first parallel conductor portion of the first conductor is inserted into a first slot of the plurality of slots,
a first parallel conductor portion of the second conductor is inserted into a second slot of the plurality of slots adjacent to the first slot,
a first parallel conductor portion of the third conductor is inserted into a third slot of the plurality of slots adjacent to the second slot and different from the first slot,
a second parallel conductor portion of the first conductor is inserted into a fourth slot of the plurality of slots different from the first slot, the second slot, and the third slot,
a second parallel conductor portion of the second conductor is inserted into a fifth slot of the plurality of slots adjacent to the fourth slot and different from the third slot, and
a second parallel conductor portion of the third conductor is inserted into a sixth slot of the plurality of slots adjacent to the fifth slot and different from the fourth slot,
the overhang portion of the first conductor comprising a first U-bend portion in a direction perpendicular to a plane defined by the two parallel conductor portions-, the first U-bend portion being formed so as to accommodate a traversing part of the overhang portion of the second conductor and a traversing part of the overhang portion of the third conductor;
the overhang portion of the second conductor comprising a second U-bend portion in a direction perpendicular to a plane defined by the two parallel conductor portions, the second U-bend portion being formed so as to accommodate a traversing part of the overhang portion of the third conductor, and
the overhang portion of the third conductor is being contained within a plane defined by the two parallel conductor portions.

16. The winding for the electric machine according to claim 1, further comprising a stator comprising the plurality of slots, wherein the rotor or the stator is the stator.

17. The winding for the electric machine according to claim 1, further comprising a rotor comprising the plurality of slots, wherein the rotor or the stator is the rotor.

18. The method for manufacturing a winding for an electric machine according to claim 15, wherein the rotor or the stator is the stator.

19. The method for manufacturing a winding for an electric machine according to claim 15, wherein the rotor or the stator is the rotor.
